(19) United States
(12) Patent Application Publication
(10) Pub. No.: US 2003/0190384 A1
(43) Pub. Date: Oct. 9, 2003

(54) Concrete rollerhead assembly

(76) Inventors: Jackie Lynn Baldwin, Franklinville, NC (US); Stephen Neill Campion, Franklinville, NC (US); David William Posey, Staley, NC (US); Thomas Milton Saunders, Franklinville, NC (US)

Correspondence Address: JENKINS & WILSON, PA, 3100 TOWER BLVD, SUITE 1400, DURHAM, NC, 27707, US

(21) Appl. No.: 10/115,661

(22) Filed: Apr. 4, 2002

(51) Int. Cl. B28B 21/26

(52) U.S. Cl. 425/262; 425/427

(57) ABSTRACT

A new and improved rollerhead for packerhead assemblies employed in concrete pipe making machines utilizing the packerhead method of pipe formation wherein the rollerhead includes a roller shaft having an upper end and a lower end, a hollow cylindrical roller body rotatably disposed around the roller shaft, a first bearing coaxially mounted about the upper end of the roller shaft and contacting an inside surface of the roller body, a second bearing coaxially mounted about the lower end of the roller shaft and contacting an inside surface of the roller body. The improvement comprises a roller body including a radially inwardly directed flange, an annular body mounted coaxially about the roller shaft, and an annular seal coaxially disposed about the annular body. The inwardly directed flange, annular body, and annular seal create a sealing system designed to prevent the infiltration of concrete contaminate matter into the rollerhead housing thus reducing wear on interior roller parts and lengthening the operative lifespan of the rollerhead assemblies.

### TECHNICAL FIELD

The present invention relates generally to an apparatus for the production of concrete pipe. More particularly, the present invention relates to an improved rollerhead assembly for use in conventional packerhead assemblies that incorporates a roller seal system for the prevention of contaminate infiltration into the concrete roller.

### BACKGROUND

Concrete pipe has been used for infrastructure development for thousands of years and has a well-established reputation for serviceability and long-lasting characteristics. Concrete pipe comes in a variety of shapes and sizes and particular pipe specifications are based on hydraulic and structural needs, cost requirements, and project site specifics such as topography and soil conditions.

The basic materials used in the production of concrete pipe are aggregate, portland cement, and water and various types of machines have been developed over the years for the casting of pipe using these materials. Different manufacturers of tubular concrete pipe have in recent years used machines which employ apparatus known as “packerheads” or “packerhead assemblies”. In such machines, a large, inverted “U” shaped mainframe is used in connection with the driveshaft to which the packerhead is connected. The packerhead typically includes a troweling cylinder, also known in the art as a longbottom, which is rotated in one direction by the driveshaft, and a plurality of distributing rollers or rollerhead assemblies which are frictionally driven by engagement with the concrete in a direction opposite to that of the driveshaft on the troweling cylinder. The axis of the plurality of rollers and the troweling cylinder extend parallel to the axis of the pipe.

The packerhead assembly is lowered into a form, and the packerhead is placed at the bottom of the form. As concrete is placed around the inside periphery of the form, the packerhead is raised. As the packerhead is raised, the friction driven rollers pack the cement or concrete against the inner surface of the mold and the troweling cylinder is counter-rotated to finish the inner surface thereby forming the pipe. When the packerhead reaches an upper pallet, the pipe is completed. The packerhead is then withdrawn from the finished pipe and the form thus provided with a molded pipe is replaced by an empty form and the pipe molding process repeated. The self-supporting formed pipe is then de-molded and stored to reach a sufficient strength after an initial curing to enable handling of the pipe and removal from the pallet.

The use of packerhead machines and methods in the production of concrete pipe is generally disclosed in numerous references including: U.S. Pat. No. 4,041,118 to Ottmann et al.; U.S. Pat. No. 4,042,315 to Ottmann et al.; U.S. Pat. No. 4,253,814 to Christian; U.S. Pat. No. 4,334,848 to Gross et al.; U.S. Pat. No. 4,340,553 to Fosse; U.S. Pat. No. 4,407,648 to Fosse; U.S. Pat. No. 4,540,539 to Crawford et al.; U.S. Pat. No. 4,600,548 to Nenna; U.S. Pat. No. 4,639,342 to Adly; U.S. Pat. No. 4,756,861 to Schultz; U.S. Pat. No. 4,957,424 to Mitchell et al.; U.S. Pat. No. 5,147,196 to Adly; U.S. Pat. No. 5,167,967 to Adly; U.S. Pat. No. 5,236,322 to Willert; U.S. Pat. No. 5,248,248 to Adly; and U.S. Pat. No. 6,106,749 to Adly.

One long-standing problem in the manufacture of tubular concrete pipe by the packerhead method is the foreign material or particles in the incoming concrete flow that can affect the manufacture of the pipe or damage internal moving parts. The coarseness of the concrete flow can cause wear damage to the external surfaces of the packerhead assembly. Also, such particulate matter can become lodged between the troweling cylinder and one or more of the distributing rollers, thereby causing the rollers to stick or jam. When jamming of this nature occurs and one or more of the rollers does not rotate, the compaction of the concrete becomes uneven and the quality of the pipe formation suffers accordingly. Additionally, contaminates in the concrete flow can infiltrate the packerhead assembly and the individual rotating rollers. Such infiltration of concrete material causes increased wear on moving components of the rollerhead assembly and more specifically can cause the interior bearings of the individual rollers to be damaged within a short period of time. This contamination of the interior bearings of the concrete rollers causes the entire packerhead machine to have to be shut down for cleaning of the individual rollers. Several patents disclose prior efforts to address these long-standing problems associated with the concrete flow in a variety of different ways.

U.S. Pat. No. 3,276,091 to Pausch discloses a rollerhead for cement pipe forming including a rollerhead and smoothing or troweling mechanism having a downwardly depending cylindrical skirt. A head plate is bolted across the upper end of the troweling cylinder. An annular array of symmetrically and circumferentially spaced, eccentrically adjustable roller packer units is disposed to extend upwardly from the head plate. An aggregate spreader plate is disposed above the roller packer units. A plurality of aggregate slingers disposed on the spreader plate are adapted to propel aggregate into the paths of the roller packer units. To guard against wear of the troweling or smoothing casing, Pausch discloses wearguards that are provided on the top of the troweling cylinder in the spaces between the roller packer units. Pausch further discloses the use of an O-ring seal between the stud and the cylinder in the roller packer units to protect the bearings. However, the use of an O-ring seal in such a manner would expose the seal to high frictional stresses, resulting in failure of the O-ring within a relatively short time. It is believe that because of the shortcomings resulting from the seal arrangement as described in Pausch, this type of rollerhead sealing system has not been adopted by the concrete pipe making industry.

U.S. Pat. No. 3,733,163 to Hermann discloses an improved wear surface for the longbottom section employed in packerhead concrete pipe making machines. The longbottom of the packerhead includes a plurality of wear segments disposed about the upper circumferential outer surface thereof.

U.S. Pat. No. 4,690,631 to Haddy discloses a packerhead concrete pipe making machine having a rotatable packerhead operable to form a concrete pipe in an upright cylindrical mold. The packerhead has a plurality of rollers rotatably mounted on a circular plate operable to pack concrete into a cylindrical shape in the mold. Each roller has an outer sleeve of elastic rubber material for greater traction on the abrasive concrete in the mold and ensuring continuous rotation of the roller during the rotation of the packerhead in the mold.

U.S. Pat. No. 5,080,571 to Crawford discloses a packerhead assembly for use in concrete pipe making machines that incorporates a longbottom assembly that utilizes a removable wearband to limit the ingress of concrete material to the interior area of the longbottom assembly around the individual rollerheads. This wearband extends upwardly from the uppermost level of the longbottom assembly to a position approximately ⅛″ from the lowermost portion of the rollers of the roller assembly.

U.S. Pat. No. 5,215,604 to Crawford discloses a packerhead assembly that incorporates a longbottom or troweling cylinder wear segment that has increased wear resistance through the use of a specific alloy.

U.S. Pat. No. 6,017,208 to Schultz discloses a concrete pipe manufacturing machine including a troweling cylinder having a head plate, a vertically movable and rotatable drive shaft fixed to the head plate for moving the troweling cylinder in a vertical direction and in one rotational direction, and a series of roller assemblies rotatably mounted on the head plate and adapted to be rotated by frictional contact with the concrete mixture in a direction counter to the one rotational direction of the drive shaft. Schultz further discloses a drive arrangement interconnecting and collectively driving the roller assemblies together for preventing jamming of the roller assemblies due to material in the concrete mixture lodging between the bottom of the rollers and the top of the head plate.

Applicant believes that all of the aforesaid efforts have suffered from various shortcomings and none have proven to be a solution to the contaminate problem.

The present invention is provided to solve these and other problems associated with the prevention of contaminates entering into the individual concrete rollers, and specifically with the prevention of contaminate damage through the use of a new and novel seal system built into each individual roller housing.

### DISCLOSURE OF THE INVENTION

In accordance with the present invention, an improved rollerhead assembly is provided for use in a machine for making a concrete product, such as concrete pipe, in an upright generally cylindrical mold. The machine has a frame, a turntable adapted to support a pallet and a cylindrical jacket or mold having a cylindrical reinforcing cage used in the formation of a tubular concrete pipe. An upper portion of the system supports a downwardly directed driveshaft and a packerhead assembly movably mounted thereon. The packerhead is adapted to be located in a mold chamber of the generally upright mold. The driveshaft is conventionally driven by a lifting means and a drive arrangement to selectively raise and lower the packerhead assembly as well as provide rotational movement such that the packerhead is concurrently rotated and elevated during the forming of the concrete pipe. The packerhead has a base plate that is connected to the drive means. A plurality of rollers are rotatably mounted on top of the base plate for rotation about separate generally upright axes. The rollers function to move and pack concrete in a generally cylindrical shape and form with the mold the cylindrical concrete pipe. Each of the rollers has an upright roller shaft secured to the plate and projected upwardly therefrom. A roller body surrounds the roller shaft and includes a radially inwardly directed flange that defines an aperture for receiving the lower end of the roller shaft. Bearings rotatably mount the body and the roller shaft. An outer wear band may be provided in a press fit relationship on the outside surface of the roller body for protection of the roller body.

A novel sealing system is provided in the present invention to prevent contaminates from entering the inside of the roller housing through the channel located between the roller shaft and the roller body. The sealing system comprises an annular body mounted coaxially about the roller shaft and disposed adjacent to the flange defined by the roller body and an annular seal coaxially disposed about the annular body. The inwardly directed flange of the roller body, the annular body, and the annular seal cooperate to provide a sealing system on the lower end of the rollerhead assembly for the prevention of concrete and other particulate matter infiltration into the roller housing. A generally cylindrical trowel is secured to the plate and extends downwardly therefrom. The trowel has an annular surface for troweling in the inside surface of a pipe during movement of the packerhead relative to the mold. The trowel may have replaceable segments of abrasion-resistant material.

Therefore, it is an object of the present invention to provide an improved rollerhead assembly for a packerhead assembly used in forming concrete pipes.

It is another object of the present invention to provide an improved rollerhead assembly that is designed for use with concrete mixes having relatively high fluidity.

Yet another object of the present invention is to provide an improved rollerhead assembly in which wear on rotating internal parts is reduced.

It is a further object of the present invention to provide an improved rollerhead assembly having a sealing system resistant to particulate matter infiltration.

Some of the objects of the invention having been stated hereinabove, other objects will become evident as the description proceeds, when taken in connection with the accompanying drawings as best described hereinbelow.

### BRIEF DESCRIPTION OF THE DRAWINGS

FIG. 1 is a vertical cross-sectional view of a concrete pipe manufacturing system equipped with a packerhead assembly embodying rollerheads of the present invention;

FIG. 2 is an enlarged sectional view taken along the line 2-2 of FIG. 1;

FIG. 3 is an enlarged vertical cross-sectional view of a prior art packerhead assembly which does not employ the rollerheads of the present invention;

FIG. 4 is an enlarged fragmentary vertical cross-sectional view of the packerhead assembly employing rollerheads of the present invention.

FIG. 5 is a vertical cross-sectional view of the rollerhead of the present invention;

FIG. 6 is a top plan view of the rollerhead of the present invention;

FIG. 7 is an exploded view of a rollerhead of the present invention;

FIG. 8 is an enlarged vertical cross-sectional side view of the lower portion of the rollerhead of the present invention; and

FIG. 9 is an enlarged vertical cross-sectional view of the seal system portion of the rollerhead of the present invention.

### DETAILED DESCRIPTION OF THE INVENTION

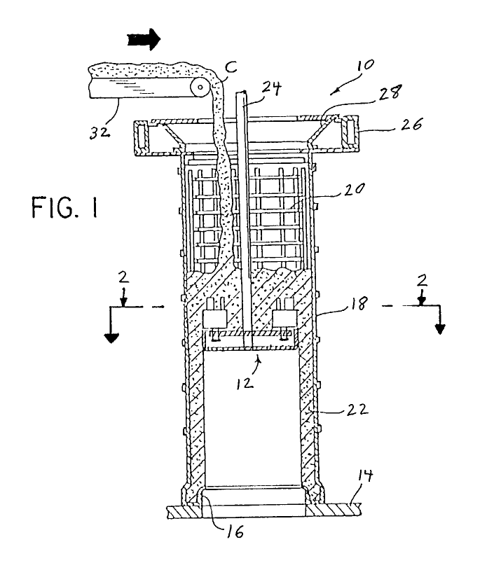

Referring to FIG. 1, there is shown a lower portion of a concrete pipe manufacturing system 10 provided with a packerhead assembly 12 embodying the rollerhead of the present invention. Typically, system 10 comprises a turntable 14 adapted to support a pallet 16 and a cylindrical jacket or mold 18 having a cylindrical reinforcing cage 20 used in the formation of a tubular concrete pipe 22. An upper portion of the system 10 supports a downwardly directed driveshaft 24 to which the packerhead assembly 12 is mounted for simultaneous movement therewith, as found in a uni-directional packerhead assembly. It is also envisioned that the improved rollerhead of the present invention can be used in a bi-directional packerhead assembly system, as is known to those skilled in the art. Driveshaft 24 is conventionally driven by a drive arrangement (not shown) mounted on the upper portion of the system 10 so as to provide rotational movement as well as vertical movement to the driveshaft 24 and the packerhead assembly 12 in a manner well known in the art. A top table 26 having a funneling mouth 28 is located above the upper end of jacket 18 for receiving a stream or flow of concrete C as delivered from a feeding device such as a conveyor 32 which directs concrete C through funneling mouth 28 and into the jacket 18 above the packerhead assembly 12. The packerhead 12 is rotated at a desired speed as it is raised relative to mold.

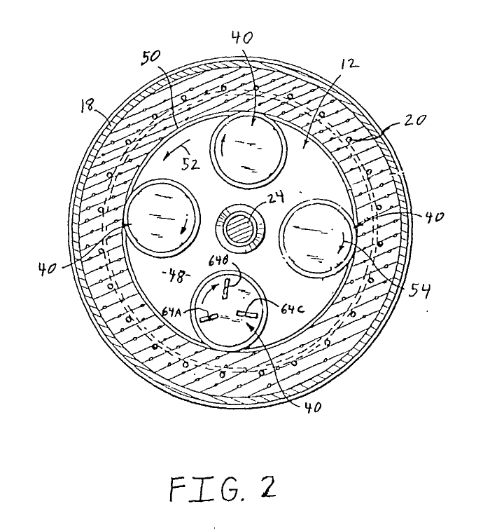

Referring to FIG. 2, there is shown the top of packerhead 12 with the concrete removed therefrom. Packerhead 12 has four circumferentially spaced rollers indicated generally at 40. Each roller rotates about a generally upright axis. Adjacent axes of the rollers are circumferentially spaced 90 degrees from each other. The axes of rollers 40 extend upwardly from roller mounting plate 48 generally parallel to the axes of rotation of driveshaft 24. Each of the rollers 40 rotate independently about their axis during the rotation of the packerhead to pack and compress the concrete in an annular configuration around the inside of mold 18 and around wire cage 20. Rollers 40 have the same diameters and vertical dimensions or height. The height of each roller is substantially the same as the height of troweling sleeve 50. As shown in FIG. 2, on rotation of packerhead 12 in the direction of the arrow 52, rollers 40 are rotated in the direction of the arrows, such as arrow 54.

Referring back to FIG. 1, as the packerhead 12 is rotated, some of the concrete is effectively forced into the annular spaces in the cylindrical reinforcing cage 20 in the gap between the outer wall of the packerhead and the inner wall of the cylindrical mold 18. As the concrete begins to cure, the packerhead 12 is raised upwardly throughout the cylindrical mold 18. The entire lining process typically occurs in less than five minutes. Once the lining is applied inside the cylindrical mold 18 and has sufficiently cured, the tubular concrete pipe 22 can be removed and another form and reinforcing cage to be lined can be positioned in the apparatus. The tubular concrete pipe 22 may then be allowed to naturally cure or be placed in a kiln to effect an accelerated final curing.

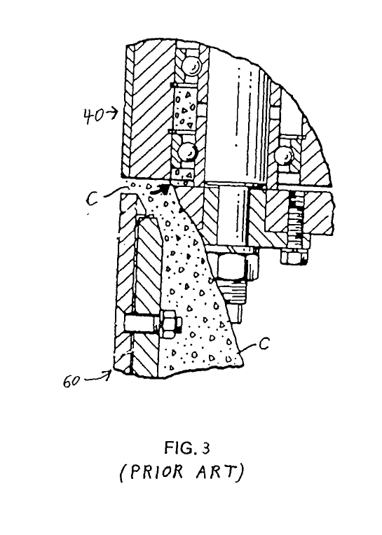

FIG. 3 is an example of a packerhead assembly using prior art rollers. As shown in FIG. 3, concrete C can enter into the interior of the packerhead and rollers. As the packerhead assembly is rotated, concrete C will be flung against the inside surface of the concrete pipes being formed. In addition, concrete C which flows radially inwardly between roller 40 and the longbottom assembly 60 can easily enter the rollerhead housing (see arrow) and contribute significantly to contamination and excess wear of the bearings which support the rollers. The extent to which concrete will enter the interior of the packerhead assembly and the rollers themselves will depend upon the fluidity of the mix and the size of the aggregate used in the mix. The novel seal system of the present invention is designed to eliminate this infiltration of concrete mix C.

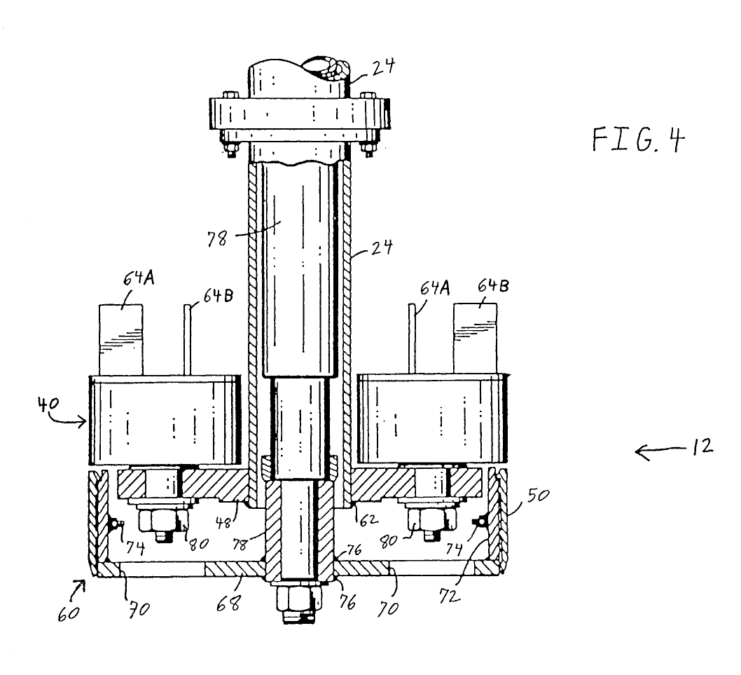

Referring now to FIG. 4, it will be seen that a rollerhead driveshaft 24 is secured, as by welds 62, to a circular roller mounting plate 48 on which a plurality of rollers 40 may be mounted. It will be understood that any desirable number of rollers may be employed. The rollers may include any type and number of distributing blades or fins 64A and 64B. A longbottom assembly is indicated generally at 60, the longbottom assembly and the rollerhead, indicated generally at 40, together with a respective drive means, comprise collectively, in this instance a bi-directional packerhead 12. The longbottom assembly 60 includes a circular bottom plate 68 having apertures 70 therein for ready access to the rollers 40. A mounting flange is indicated at 72, the mounting flange carrying a smooth, circular roller distributor blade or troweling sleeve 50 which is secured entirely around the periphery of the mounting flange 72 by any suitable fastening means 74. Circular bottom plate 68 is welded, as at 76, to a long bottom driveshaft indicated at 78, thus depicting a bi-directional packerhead assembly.

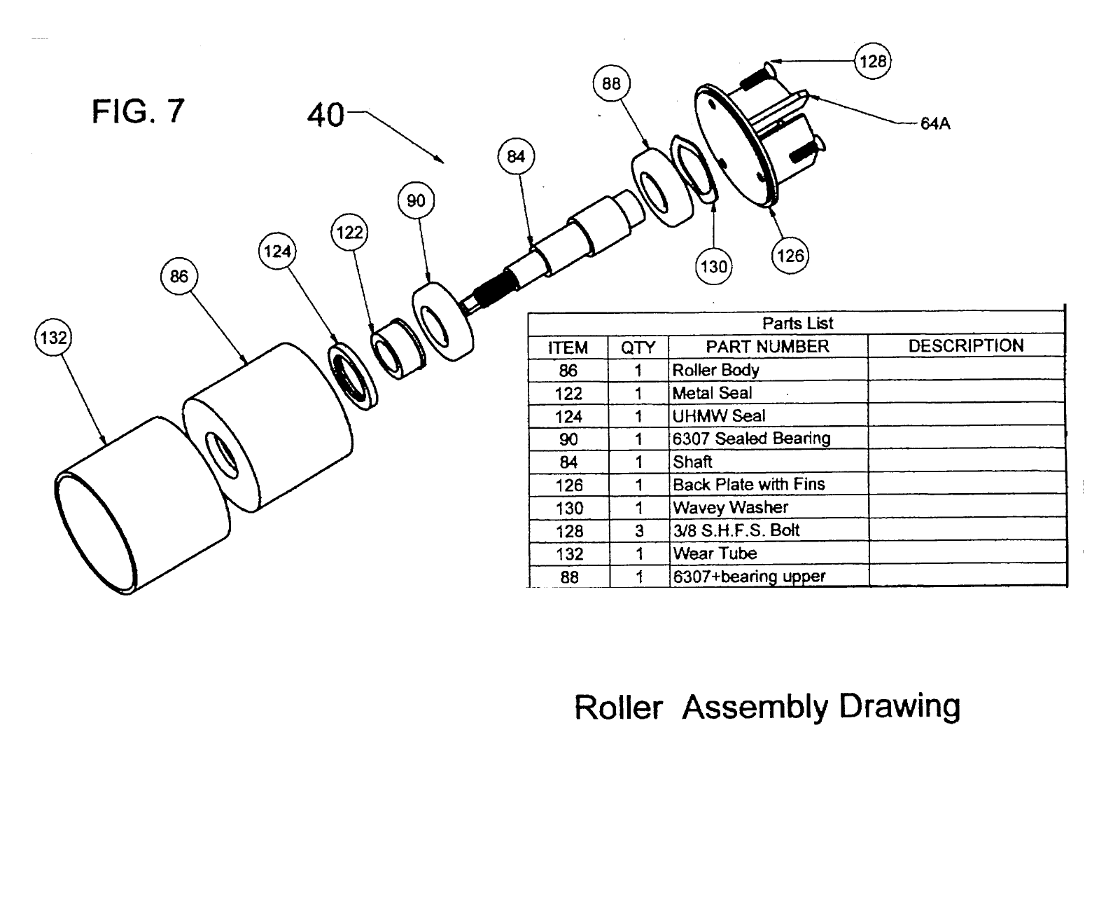

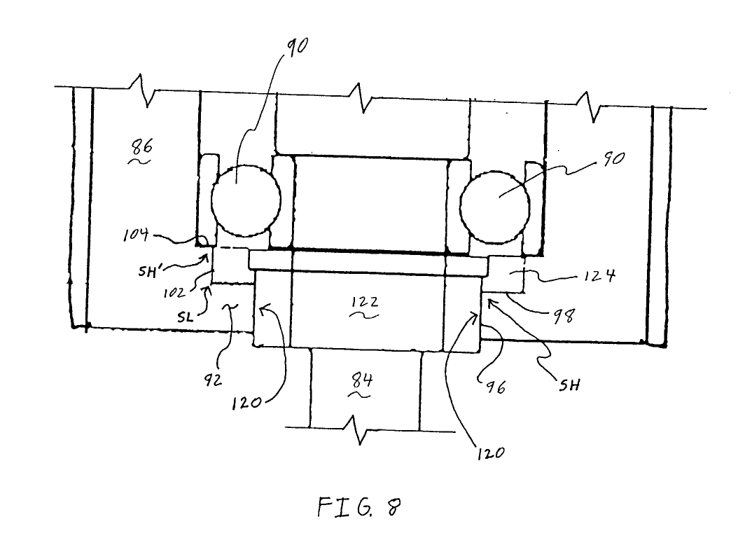

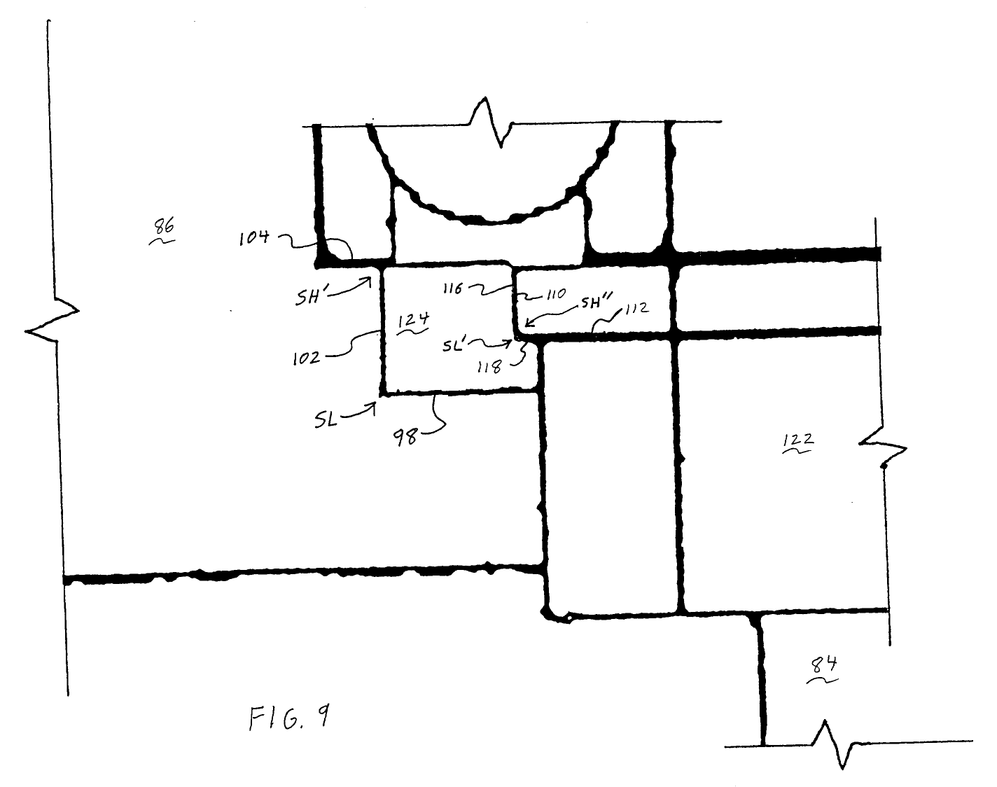

Referring now to FIGS. 5-9, a rollerhead 40 of the present invention is provided for use with a packerhead assembly 12. The backbone or central element of rollerhead 40 is roller shaft 84, to which all other components attach. Roller shaft 84 has an upper end and a lower end. A cylindrical roller body 86 of metal or like rigid material surrounds roller shaft 84. A pair of first 88 and second 90 bearings are coaxially mounted about roller shaft 84 and rotatably contact the inside surface of roller body 86. In a preferred embodiment, sealed bearings will be used in order to further protect internal parts from additional wear. Although any form of bearing means as known to those skilled in the art may be used, it is recommended that unsealed bearings not be used as their use may significantly shorten the useful life of the rollerhead assembly. As shown in more detail in FIG. 8, in the novel seal system of the present invention, roller body 86 includes a radially inwardly directed flange 92 that defines an aperture, shown generally at 120, therein to receive the lower end of roller shaft 84 therethrough (as shown in FIG. 7). The flange comprises a first annular shoulder SH adjacent the aperture 120 that includes an axial surface 96 and a radial surface 98. The flange further comprises a second annular shoulder SH′ located adjacent to the first annular shoulder SH and inwardly of the roller body 86 and including an axial surface 102 and a radial surface 104. An annular body 122 of metal or like rigid material is mounted coaxially about the lower end of the roller shaft 84 and is disposed adjacent to the axial surface 96 of the first annular shoulder SH and within the aperture 120 defined by the flange 92. The annular body 122 may be in press fit relationship to the roller shaft 84. An annular seal 124 of ultra high molecular weight (UHMW) polyethylene or like material is coaxially disposed about the annular body 122 and interposed between the radial surface 98 of the first annular shoulder SH and the second bearing 90 mounted about the lower end of the roller shaft 84. The radial surface 98 of the first annular shoulder SH and the axial surface 102 of the second annular shoulder SH′ are coaxially disposed around annular seal 124 so as to provide an annular slot SL in the flange 92 for receiving the annular seal 124 therein.

As shown in more detail in FIG. 9, annular body 122 further comprises an annular shoulder SH″ proximate to the upper end of the roller shaft 84 and including an axial surface 110 and a radial surface 112. The annular seal 124 further comprises an annular slot SL′ therein including an axial surface 116 and a radial surface 118 for receiving the annular shoulder SH″ of annular body 122.

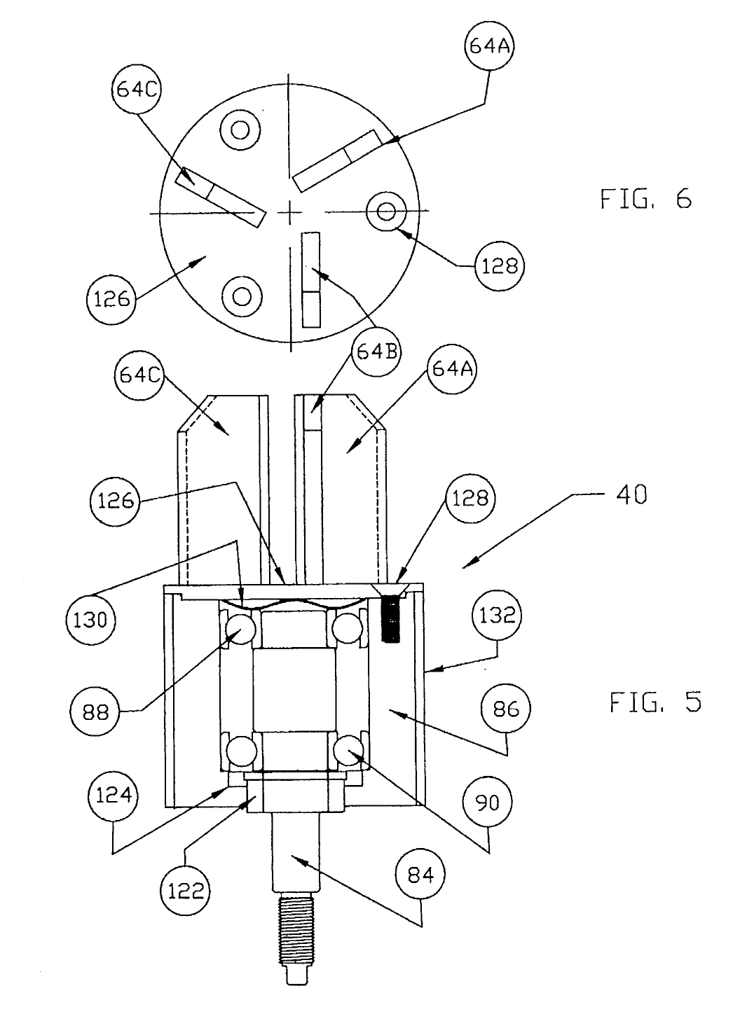

Referring back to FIG. 5, the upper end of the rollerhead may be closed by the use of a back plate cap or flat cap 126 secured with a plurality of bolts, screws, or other suitable fastening means 128. The flat cap 126 covers the top of roller body 86 and retains lubricants within the roller body 86. A wavy washer or other similar dampening element 130 may be mounted between the closed upper end of the roller body and the first bearing 88 mounted about the upper end of the roller shaft. The dampening element 130 acts as a shock absorber for the roller 40 and additionally keeps the first bearing 88 in its proper location during operations. Flat cap 126 may contain a plurality of upwardly directed generally flat distributing fins or blades 64A, 64B and 64C which are operable to work and move concrete toward the inner wall of mold 18. Referring to FIG. 6, fins 64A-64C are evenly distributed upon flat cap 126. The fins 64A-64C generally have a vertical height that is substantially the same as the vertical height of roller 40. Referring back to FIG. 5, a continuous wear band, tube or sleeve 132 of metal or elastic abrasive resistant material is located about roller body 86. Wear band 132 is press fitted onto the outside cylindrical surface of roller body 86. Wear band 132 has an inside cylindrical surface that is smaller than the outer cylindrical surface of roller body 86. When wear band 132 is press fitted onto roller body 86, it is under continuous tension whereby the band is retained on the body. In the event that wear band 132 is damaged or worn, it can be removed from roller body 86 and replaced with a new wear band. Wear band 132 has a continuous cylindrical outer surface that engages the concrete as roller 40 rolls about its upright axis thereby exerting an opposite force on the concrete C.

Upon assembly of the rollerhead, each roller is mounted on the roller mounting plate 48 through the placement of the threaded cylindrical hub portion of the lower end of the roller shaft through a hole in roller mounting plate 48, as shown in FIG. 4. The threaded end of the cylindrical hub projects downwardly from the plate roller mounting plate and accommodates a nut 80 (see FIG. 4) for rigidly fixing the roller shaft to the roller mounting plate. Nut 80 can be removed from the lower end of the roller shaft 84 to allow roller 40 to be removed from the roller mounting plate 48 for servicing or replacement.

In use, as packerhead 12 is rotated, the concrete C is worked and pressed around the reinforcing wire cage 20 and against the inside of the wall of cylindrical mold 18 to form a cylindrical concrete wall. All of the rollers 40 continuously work and pack concrete during the rotation of packerhead 12. The annular troweling sleeve 50 provides a continuous annular trowel that finishes the inside surface of pipe 22. The packing and troweling action of packerhead 12 is continuous during its rotational and vertical movements from the bottom of the mold to the top ring of the mold. Packerhead 12 forms a smooth inside surface of the concrete pipe as illustrated in FIG. 1.

As shown in FIG. 3 and described hereinabove, prior art rollers consisted of open designs that essentially brought the roller body up against the roller shaft, thereby creating an “open channel” for concrete particulates and other contaminates to enter the roller housing and damage interior parts such as bearings. One prior art reference suggested using an O-ring seal, but due to frictional wear and other limiting factors, this O-ring configuration was never in wide-spread use and is not used in the industry today. The novel sealing system of applicants' invention incorporates a new and novel roller body design that works in conjunction with a separate annular body and annular seal to create a labyrinth or maze that effectively functions as a seal for preventing particulate matter infiltration into the roller housing. The roller body flange and annular body design incorporates a seating arrangement in which the annular seal rests between the two structures thus not exposing the annular seal to frictional stresses. The rollers incorporating the novel seal system of the present invention are not as susceptible to contamination by concrete particles found in varying consistencies of concrete mixes. The prevention of particulate matter infiltration allows the internal bearings and other moving parts to remain functional, leading to substantially less wear on the roller assembly and to a longer operative life for the internal components thereof. Moreover, the improved rollerhead of the present invention is designed to be as easily serviceable as prior art rollers. The design of the roller body, annular body, and annular seal are such as to allow the roller shaft drive unit to push through the roller body for inspection and servicing. The unique roller design permits ease of maintenance while limiting contaminate infiltration and associated rollerhead damage.

It will be further understood that various other details or features of the invention may be changed without departing from the scope of the invention. Furthermore, the foregoing description is for the purpose of illustration only, and not for the purpose of limitation—the invention being defined by the claims.

What is claimed is:

1. In a rollerhead for a packerhead assembly used in forming concrete pipes and including a roller shaft having an upper end and a lower end, a hollow cylindrical roller body rotatably disposed around the roller shaft, a first bearing coaxially mounted about the upper end of the roller shaft and contacting an inside surface of the roller body, a second bearing coaxially mounted about the lower end of the roller shaft and contacting an inside surface of the roller body, the improvement comprising:
(a) the roller body including a radially inwardly directed flange defining an aperture therein for receiving the lower end of the roller shaft therethrough, the flange comprising a first annular shoulder adjacent the aperture including an axial surface and a radial surface;
(b) an annular body mounted coaxially about the roller shaft and disposed adjacent to the axial surface of the first annular shoulder and within the aperture defined by the flange; and
(c) an annular seal coaxially disposed about the annular body and interposed between the radial surface of the first annular shoulder and the second bearing mounted about the lower end of the roller shaft.

2. The rollerhead of claim 1 wherein the flange of the roller body comprises a second annular shoulder located adjacent to the first annular shoulder and inwardly of the roller body and including an axial surface and a radial surface, and the radial surface of the first annular shoulder and the axial surface of the second annular shoulder are coaxially disposed around the annular seal so as to provide an annular slot in the flange for receiving the annular seal therein.

3. The rollerhead of claim 1 wherein the annular body is press fit onto the roller shaft.

4. The rollerhead of claim 1 wherein the annular body comprises an annular shoulder proximate to the upper end of the roller shaft and including an axial surface and a radial surface.

5. The rollerhead of claim 4 wherein the annular seal comprises an annular slot therein including an axial surface and a radial surface for receiving therein the annular shoulder of the annular body.

6. The rollerhead of claim 1 wherein the annular seal consists of ultra-high molecular weight polyethylene.

7. The rollerhead of claim 1 wherein the upper end of the roller body is closed.

8. The rollerhead of claim 7 wherein the upper end of the roller body is closed by a cap mounted directly on the top end of the roller body.

9. The rollerhead of claim 8 including at least one upright fin secured to the cap.

10. The rollerhead of claim 7 including a dampening element mounted between the closed upper end of the roller body and the first bearing mounted about the upper end of the roller shaft.

11. The rollerhead of claim 1 including a hollow cylindrical wear band coaxially mounted about the roller body.

12. The rollerhead of claim 11 wherein the wear band is press fit onto the roller body.

13. In a rollerhead for a packerhead assembly used in forming concrete pipes and including a roller shaft having an upper end and a lower end, a hollow cylindrical roller body rotatably disposed around the roller shaft, a first bearing coaxially mounted about the upper end of the roller shaft and contacting an inside surface of the roller body, a second bearing coaxially mounted about the lower end of the roller shaft and contacting an inside surface of the roller body, the improvement comprising:
(a) the roller body including a radially inwardly directed flange defining an aperture therein for receiving the lower end of the roller shaft therethrough, the flange comprising a first annular shoulder adjacent the aperture including an axial surface and a radial surface, the flange further comprising a second annular shoulder located adjacent to the first annular shoulder and inwardly of the roller body and including an axial surface and a radial surface;
(b) an annular body mounted coaxially about the roller shaft and disposed adjacent to the axial surface of the first annular shoulder and within the aperture defined by the flange;
(c) an annular seal coaxially disposed about the annular body and interposed between the radial surface of the first annular shoulder and the second bearing mounted about the lower end of the roller shaft; and
(d) wherein the radial surface of the first annular shoulder and the axial surface of the second annular shoulder are coaxially disposed around the annular seal so as to provide an annular slot in the flange for receiving the annular seal therein.

14. The rollerhead of claim 13 wherein the annular body is press fit onto the roller shaft.

15. The rollerhead of claim 13 wherein the annular body comprises an annular shoulder proximate to the upper end of the roller shaft and including an axial surface and a radial surface.

16. The rollerhead of claim 15 wherein the annular seal comprises an annular slot therein including an axial surface and a radial surface for receiving therein the annular shoulder of the annular body.

17. The rollerhead of claim 13 wherein the annular seal consists of ultra-high molecular weight polyethylene.

18. The rollerhead of claim 13 wherein the upper end of the roller body is closed.

19. The rollerhead of claim 18 wherein the upper end of the roller body is closed by a cap mounted directly on the top end of the roller body.

20. The rollerhead of claim 19 including at least one upright fin secured to the cap.

21. The rollerhead of claim 18 including a dampening element mounted between the closed upper end of the roller body and the first bearing mounted about the upper end of the roller shaft.

22. The rollerhead of claim 13 including a hollow cylindrical wear band coaxially mounted about the roller body.

23. The rollerhead of claim 22 wherein the wear band is press fit onto the roller body.

24. In a concrete pipe forming machine including a packerhead assembly axially movable and rotatable about the longitudinal axis of a mold to which a concrete mixture is delivered, the packerhead assembly including a plurality of rollerheads for packing the concrete against the inner surface of the mold, each rollerhead including a roller shaft having an upper end and a lower end, a hollow cylindrical roller body rotatably disposed around the roller shaft, a first bearing coaxially mounted about the upper end of the roller shaft and contacting an inside surface of the roller body, a second bearing coaxially mounted about the lower end of the roller shaft and contacting an inside surface of the roller body, the improvement wherein each rollerhead comprises:
(a) the roller body including a radially inwardly directed flange defining an aperture therein for receiving the lower end of the roller shaft therethrough, the flange comprising a first annular shoulder adjacent the aperture including an axial surface and a radial surface;
(b) an annular body mounted coaxially about the roller shaft and disposed adjacent to the axial surface of the first annular shoulder and within the aperture defined by the flange; and
(c) an annular seal coaxially disposed about the annular body and interposed between the radial surface of the first annular shoulder and the second bearing mounted about the lower end of the roller shaft.

25. The rollerhead of claim 24 wherein the flange of the roller body comprises a second annular shoulder located adjacent to the first annular shoulder and inwardly of the roller body and including an axial surface and a radial surface, and the radial surface of the first annular shoulder and the axial surface of the second annular shoulder are coaxially disposed around the annular seal so as to provide an annular slot in the flange for receiving the annular seal therein.

26. The rollerhead of claim 24 wherein the annular body is press fit onto the roller shaft.

27. The rollerhead of claim 24 wherein the annular body comprises an annular shoulder proximate to the upper end of the roller shaft and including an axial surface and a radial surface.

28. The rollerhead of claim 27 wherein the annular seal comprises an annular slot therein including an axial surface and a radial surface for receiving therein the annular shoulder of the annular body.

29. The rollerhead of claim 24 wherein the annular seal consists of ultra-high molecular weight polyethylene.

30. The rollerhead of claim 24 wherein the upper end of the roller body is closed.

31. The rollerhead of claim 30 wherein the upper end of the roller body is closed by a cap mounted directly on the top end of the roller body.

32. The rollerhead of claim 31 including at least one upright fin secured to the cap.

33. The rollerhead of claim 30 including a dampening element mounted between the closed upper end of the roller body and the first bearing mounted about the upper end of the roller shaft.

34. The rollerhead of claim 24 including a hollow cylindrical wear band coaxially mounted about the roller body.

35. The rollerhead of claim 34 wherein the wear band is press fit onto the roller body.

36. In a concrete pipe forming machine including a packerhead assembly axially movable and rotatable about the longitudinal axis of a mold to which a concrete mixture is delivered, the packerhead assembly including a plurality of rollerheads for packing the concrete against the inner surface of the mold, each rollerhead including a roller shaft having an upper end and a lower end, a hollow cylindrical roller body rotatably disposed around the roller shaft, a first bearing coaxially mounted about the upper end of the roller shaft and contacting an inside surface of the roller body, a second bearing coaxially mounted about the lower end of the roller shaft and contacting an inside surface of the roller body, the improvement wherein each rollerhead comprises:
(a) the roller body including a radially inwardly directed flange defining an aperture therein for receiving the lower end of the roller shaft therethrough, the flange comprising a first annular shoulder adjacent the aperture including an axial surface and a radial surface, the flange further comprising a second annular shoulder located adjacent to the first annular shoulder and inwardly of the roller body and including an axial surface and a radial surface;
(b) an annular body mounted coaxially about the roller shaft and disposed adjacent to the axial surface of the first annular shoulder and within the aperture defined by the flange;
(c) an annular seal coaxially disposed about the annular body and interposed between the radial surface of the first annular shoulder and the second bearing mounted about the lower end of the roller shaft; and
(d) wherein the radial surface of the first annular shoulder and the axial surface of the second annular shoulder are coaxially disposed around the annular seal so as to provide an annular slot in the flange for receiving the annular seal therein.

37. The rollerhead of claim 36 wherein the annular body is press fit onto the roller shaft.

38. The rollerhead of claim 36 wherein the annular body comprises an annular shoulder proximate to the upper end of the roller shaft and including an axial surface and a radial surface.

39. The rollerhead of claim 38 wherein the annular seal comprises an annular slot therein including an axial surface and a radial surface for receiving therein the annular shoulder of the annular body.

40. The rollerhead of claim 36 wherein the annular seal consists of ultra-high molecular weight polyethylene.

41. The rollerhead of claim 36 wherein the upper end of the roller body is closed.

42. The rollerhead of claim 41 wherein the upper end of the roller body is closed by a cap mounted directly on the top end of the roller body.

43. The rollerhead of claim 42 including at least one upright fin secured to the cap.

44. The rollerhead of claim 41 including a dampening element mounted between the closed upper end of the roller body and the first bearing mounted about the upper end of the roller shaft.

45. The rollerhead of claim 36 including a hollow cylindrical wear band coaxially mounted about the roller body.

46. The rollerhead of claim 45 wherein the wear band is press fit onto the roller body.
